(19) United States
(12) Patent Application Publication
(10) Pub. No.: US 2019/0169931 A1
(43) Pub. Date: Jun. 6, 2019

(54) PLATFORMS FOR TEMPORARY STRUCTURES AND METHODS OF ASSEMBLING THE SAME

(71) Applicant: Bright Structures Ltd., Exeter (GB)

(72) Inventor: Stephen Bright, Exeter (GB)

(21) Appl. No.: 16/209,634

(22) Filed: Dec. 4, 2018

(30) Foreign Application Priority Data
Dec. 4, 2017 (GB) GB1720135.1

(51) Int. Cl. E06C 1/10; E06C 1/28; E06C 1/39; E06C 7/16; E04G 1/30; E01D 15/133; E01D 15/12

(52) U.S. Cl. CPC E06C 1/10; E06C 1/28; E06C 1/39; E06C 7/083; E04G 1/30; E01D 15/133; E01D 15/124; E06C 7/16

(57) ABSTRACT

A platform (10) comprising two or more ladders (20, 30), of the type having stiles (25, 26) and rungs (40), releasably attachable together in a side-by-side arrangement such that the rungs of each ladder are in the same plane, at least two of the rungs on each ladder being hollow, the platform further comprising a first elongate member (50) arranged to pass through co-axially positioned hollow rungs of each ladder, the first elongate member comprising a widened portion at one end thereof, and a releasable locking member (60) at the other end thereof, to releasably clamp the ladders together, the platform further comprising at least one deck plate (110) arrangeable on the rungs of one of the two or more ladders to form a deck.

### RELATED APPLICATIONS

This application claims priority under 35 U.S.C. § 119 to co-pending UK Application GB1720135.1, filed Dec. 4, 2017 and incorporated by reference herein in its entirety.

### BACKGROUND

### Field

The present invention relates generally to a platform and a method of assembling a platform and finds particular, although not exclusive, utility in providing temporary structures.

### SUMMARY

In certain situations, it is desirable to construct structures for a variety of purposes in a relatively short time, where the materials used are modular and relatively lightweight to the extent that lifting equipment may not be required. Such purposes may include gantries, platforms, bridges, roadways, flood barriers, and roofs.

The present invention describes equipment that may be used to satisfy such a desire.

In a first aspect, the invention provides a platform comprising two or more ladders, of the type having stiles and rungs, releasably attachable together in a side-by-side arrangement such that the rungs of each ladder are in the same plane, at least two of the rungs on each ladder being hollow, the platform further comprising a first elongate member arranged to pass through co-axially positioned hollow rungs of each ladder, the first elongate member comprising a widened portion at one end thereof, and a releasable locking member at the other end thereof, to releasably clamp the ladders together, the platform further comprising at least one deck plate arrangeable on the rungs of one of the two or more ladders to form a deck.

Each ladder may have a length in the range of 1 to 6 metres. In this respect, the term “ladder” may refer to an ordinary, commonly available ladder having two stiles and a number of rungs. However, the ladders may be manufactured to include additional features not typically found on commonly available ladders.

The ladders may comprise aluminium or similar lightweight materials including advanced composite materials.

Each ladder may have stiles with substantially rectangular cross-sections, although “C” section cross-sections are also contemplated. Each stile may therefore have an upper surface, a lower surface being the one parallel to the upper surface and spaced apart by the sides of the stiles, and two side surfaces through which rungs pass. The inside surfaces are the surfaces facing each other across the length of the rungs. The outside surfaces are the surfaces facing away from the rungs.

The stiles of the two ladder sections may have the same spacing, measured from inside side surface to inside surface.

The ladders may have a width in the range of 20 cm to 100 cm.

The deck plate may rest on top of the rungs and within the stiles. The deck plate allows for traffic across the ladders as well as having other useful effects. The deck may be arranged to have a thickness equal to the distance of the side of the rung from the upper surface of the stiles such that the deck forms a substantially uniform a planar surface with the upper surfaces of the stiles. The deck plate may comprise timber, plastics, aluminium, or composite materials and be solid or hollow.

The deck plate may include openings within them, and a projection for preventing it from sliding across the rungs. For instance, bars, or projecting bolts may be arranged on the ladder side of the deck plate to engage with the rungs. The deck plates may include stiffeners which bear on at least some of the rungs and contact the side of the rungs to secure them in place.

The releasable locking member may be a threaded nut and at least a portion of the elongate member may have a corresponding thread for adjustable attachment of the nut thereto. In this way, the elongate member may be passed through the co-axial rungs such that the widened portion abuts the end of one rung. The nut may then be wound onto the threaded end which projects from the distal end of the adjacent rung. The nut may be rotated to provide the desired amount of clamping action. In this respect, the nut is arranged to be larger than the bore of the hollow rung, or a washer may be provided to create the same clamping effect.

Other ways of releasably clamping the adjacent ladders together are contemplated, such as the releasable locking member being a pin arranged to extend at least partially into a hole arranged in the first elongate member. For instance, a lynch pin may pass completely through the first elongate member from one side to the other. Alternatively, a sprung pin biased to project out of the first elongate member may be provided.

The widened portion may be a flared portion of the first elongate member. Alternatively, it may a separate member such as a nut or washer. It may be releasably attached to the first elongate member. It may be arranged to be reversibly transformable into a narrower portion to allow its passage through the hollow rung. For instance, a sprung pin biased to project out of the first elongate member may be provided.

The elongate member may be flexible or rigid. For instance, the member may a rope with a knot at one end.

The platform may further comprise a stabilising member arranged for placement between two adjacent ladders to maintain the rungs of both ladders in the same plane without the elongate member.

The stabilising member may have a cross-sectional (Roman letter) “I” shape in the form of two parallel flanges spaced apart from one another by an intermediate perpendicularly arranged web, the web may be arranged to be positioned parallel to, and between, the outside surfaces of the adjacent stiles, one flange may be arranged to lie adjacent and parallel to the upper surfaces of the two adjacent stiles of the two adjacent ladders, and the other flange may be arranged to lie adjacent and parallel to the lower surfaces of the two adjacent stiles.

The stabilising member may include a hole to accommodate the first elongate member. One or more of these stabilising members may be employed to maintain the two adjacent ladders in position relative to one another to aid the insertion of one or more first elongate members into co-axial hollow rungs.

The rungs may project through an outer surface of the stile. The projection may be in the range of 1 to 30 mm.

The hole in the stabilising member may be arranged to fit around the rung projection.

The stabilising member may include a bracket for attaching a stiffening member across the width of one or more of the two or more ladders. The stiffening member may be a relatively rigid rod and may be arranged underneath the ladders, in use.

The platform may further comprise a removably attachable side bracket including a hole, the hole may be arranged to fit around the projecting rung, the side bracket may be attachable to the platform by use of the first elongate member and releasable locking member, the side bracket may be arranged to enable other members to be releasably attached to the platform.

For instance, one of the other members may be the stiffening member referred to above.

The platform may further comprise at least one baluster, the baluster may be attachable to the platform by use of the first elongate member and releasable locking member.

The side bracket may include a projection and the at least one baluster may include a recess for fitting around the projection. The at least one baluster may include a hole for receiving the stiffening member therethrough.

The platform may further comprise a handrail releasably attachable to the at least one baluster.

At least one hollow rung may include a connector for connecting other members to the platform. The connector may comprise a threaded portion on the internal surface of the rung adjacent the stile, the threaded portion adapted to receive a correspondingly externally threaded member for releasably attaching the member to the platform.

Other ways of connecting other members to the platform are contemplated, such as, the connector comprising a hollow sleeve arranged to be inserted into, and removably fixed to, the hollow rung, the sleeve comprising a threaded portion on its internal surface, the threaded portion adapted to receive a correspondingly externally threaded member for releasably attaching the member to the platform.

Another possibility is that the connector comprises a second elongate member arranged to be inserted into, and removably fixed to, the hollow rung, the second elongate member including at least one hole arranged to receive at least a portion of a pin for releasably attaching the member to the platform.

In this respect, the phrase “removably fixed to the hollow rung” includes the situation where the second elongate member is rotatable within the hollow rung but is prevented from moving parallel to the longitudinal length of the hollow bore of the rung.

The at least one stile may include a hole through its side arranged to receive a pin for releasably attaching the at least one deck plate to the platform. In this regard, the pin may pass through the stile from the outside surface to the inside surface and extend into a co-axially arranged hole in the side of the deck plate.

The platform may further comprise discrete spacer elements for maintaining a gap between at least one side of the at least one deck plate and at least one of the corresponding internal surfaces of the stiles of one ladder.

The at least one deck plate may comprise at least one flexible seal for substantially sealing the gap between at least one side of the at least one deck plate and the at least one corresponding internal surface of the stile. In this way, the gaps may become substantially water-proof.

The hole may be co-axially aligned with at least one spacer element.

The platform may further comprise an infill member for filling the gap between the outer side surfaces of the immediately adjacent stiles of two adjacent ladders. This may be desirable because the gap may be in the range of 5 to 60 mm depending on various factors such as the length of projection of the rungs, the thickness of any stabilising member and manufacturing tolerances. The infill member may have a (Roman letter) “T” shape. In this way, the horizontal part may rest on the upper surfaces of the adjacent stiles and the vertical part may rest between the outside surfaces of the adjacent stiles. Alternative shapes are contemplated such as a square shape where the upper part of the square sits flush with the upper surfaces of the adjacent stiles, and the lower surface is supported on the ladder rung projections.

The platform may further comprise a platform connector for connecting it to another platform. In this way a larger platform may be created. The platform connector may fit into the ends of stiles.

The platform connector may be arranged to connect the two platforms such that all the rungs lie in the same plane. However, it is contemplated that the platform connector may be arranged to connect the two platforms such that all the rungs of one platform lie in one plane and all the rungs in the other platform lie in another plane. In this way, an apex shape roof structure may be created.

The platform connector may include an angle adjuster to variably adjust the angle between the plane in which the rungs lie in one platform and the plane in which the rungs lie in the other platform. For instance, a hinged connector.

The platform may further comprise at least one releasably attachable mast and cord for stiffening the platform, the mast attachable such that its longitudinal axis lies non-parallel to the plane in which the rungs lie, the cord arranged to link the mast to the platform such that its longitudinal axis also lies non-parallel to the plane in which the rungs lie. More than one cord and/or mast may be provided.

In a second aspect, the invention provides a method of assembling a platform according to any preceding claim, comprising the steps of providing at least two, of the type having stiles and rungs, wherein at least two of the rungs on each ladder are hollow, placing these at least two hollow rungs co-axially and providing and inserting a first elongate member through them, the first elongate member comprising a widened portion at one end thereof, the method also comprising the step of providing a releasable locking member at the other end thereof, and locking the locking member to the first elongate member to clamp the ladders together.

### BRIEF DESCRIPTION OF THE DRAWINGS

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

FIG. 1 is a perspective view of a platform;

FIG. 2 is a cross-sectional side view of a stabilising member and portions of two adjacent ladders;

FIG. 3 is a perspective view of another platform;

FIG. 4 is a cross-sectional side view of a portion of a platform and side bracket;

FIG. 5 is a perspective view of a platform acting as a bridge;

FIG. 6 is a cross-sectional side view of a portion of a platform and a different side bracket;

FIG. 7 is a cross-sectional side view of a portion of a platform and an alternative side bracket;

FIG. 8 is a cross-sectional side view of a portion of a platform with a deck plate;

FIG. 9 is a cross-sectional side view of a portion of a platform and a winder;

FIG. 10 is a schematic view of a fixed angle platform connection member;

FIG. 11 is a schematic view of a variable angle platform connector; and

FIG. 12 is a perspective view of a roof structure under construction.

### DETAILED DESCRIPTION

The present invention will be described with respect to certain drawings but the invention is not limited thereto but only by the claims. The drawings described are only schematic and are non-limiting. Each drawing may not include all of the features of the invention and therefore should not necessarily be considered to be an embodiment of the invention. In the drawings, the size of some of the elements may be exaggerated and not drawn to scale for illustrative purposes. The dimensions and the relative dimensions do not correspond to actual reductions to practice of the invention.

Furthermore, the terms first, second, third and the like in the description and in the claims, are used for distinguishing between similar elements and not necessarily for describing a sequence, either temporally, spatially, in ranking or in any other manner. It is to be understood that the terms so used are interchangeable under appropriate circumstances and that operation is capable in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that operation is capable in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Reference throughout this specification to “an embodiment” or “an aspect” means that a particular feature, structure or characteristic described in connection with the embodiment or aspect is included in at least one embodiment or aspect of the present invention. Thus, appearances of the phrases “in one embodiment”, “in an embodiment”, or “in an aspect” in various places throughout this specification are not necessarily all referring to the same embodiment or aspect, but may refer to different embodiments or aspects. Furthermore, the particular features, structures or characteristics of any embodiment or aspect of the invention may be combined in any suitable manner, as would be apparent to one of ordinary skill in the art from this disclosure, in one or more embodiments or aspects.

Similarly, it should be appreciated that in the description various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Moreover, the description of any individual drawing or aspect should not necessarily be considered to be an embodiment of the invention. Rather, as the following claims reflect, inventive aspects lie in fewer than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some features included in other embodiments, combinations of features of different embodiments are meant to be within the scope of the invention, and form yet further embodiments, as will be understood by those skilled in the art. For example, in the following claims, any of the claimed embodiments can be used in any combination.

In the description provided herein, numerous specific details are set forth. However, it is understood that embodiments of the invention may be practised without these specific details. In other instances, well-known methods, structures and techniques have not been shown in detail in order not to obscure an understanding of this description.

In the discussion of the invention, unless stated to the contrary, the disclosure of alternative values for the upper or lower limit of the permitted range of a parameter, coupled with an indication that one of said values is more highly preferred than the other, is to be construed as an implied statement that each intermediate value of said parameter, lying between the more preferred and the less preferred of said alternatives, is itself preferred to said less preferred value and also to each value lying between said less preferred value and said intermediate value.

The use of the term “at least one” may mean only one in certain circumstances. The use of the term “any” may mean “all” and/or “each” in certain circumstances.

The principles of the invention will now be described by a detailed description of at least one drawing relating to exemplary features. It is clear that other arrangements can be configured according to the knowledge of persons skilled in the art without departing from the underlying concept or technical teaching, the invention being limited only by the terms of the appended claims.

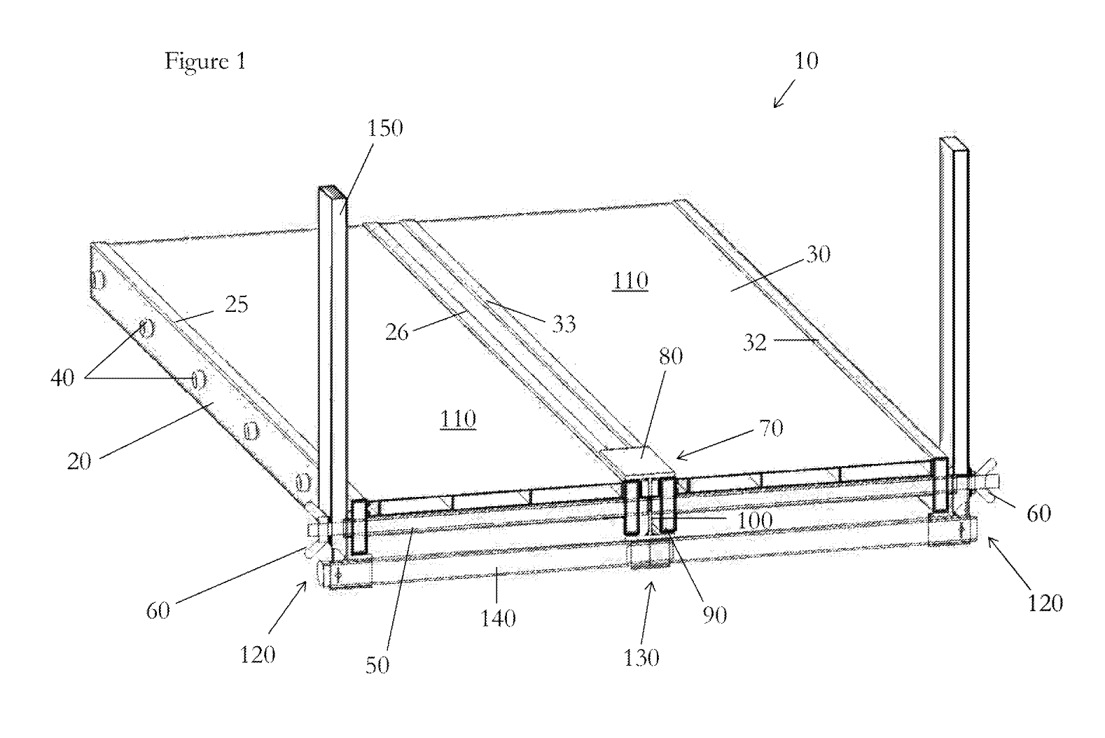

In FIG. 1, the platform 10 comprises two ladders 20, 30 located adjacent one another side-by-side. The ladder 20 on the left has a left stile 25 and a right stile 26. The ladder on the right has a left stile 33 and a right stile 32. The ladders have rungs 40 which project outwardly from the stiles. The rungs at the nearest end of the platform 10 are hollow such that an elongate member 50 has been inserted therethrough. In this case the elongate member is a threaded bar and a butterfly nut 60 is arranged at each end. These may be wound onto the bar and tightened thus clamping the ladders together. The hollow rungs may an internal diameter of 20 mm and the elongate member 50 may have an external diameter of 16 mm.

A stabilising member 70 is arranged between the two ladders. It is in the form of an I beam having an upper surface which lies over the upper surface 80 of the stiles 26, 33, and a lower surface 90 which lies under the lower surfaces of the same stiles. The upper 80 and lower 90 surfaces are connected together by a web 100 which extends between them and which sits between the outer surfaces of the two stiles. A hole, not shown, in the web allows the elongate member 50 to pass therethrough.

Side brackets 120 are attached to the elongate member at each end thereof. Another bracket 130 is arranged underneath the stabilising member 70.

A stiffening member 140, in the form of a rod, is arranged underneath the platform and held in place by the side brackets 120 and stabilising bracket 130.

Balusters 150 are attached to the platform by use of a hole in their lower ends, through which the projecting rung 40 may pass, and being clamped between the butterfly nut 60 and the outer surface of the stiles.

Deck plates 110 have been placed on top of the rungs 40.

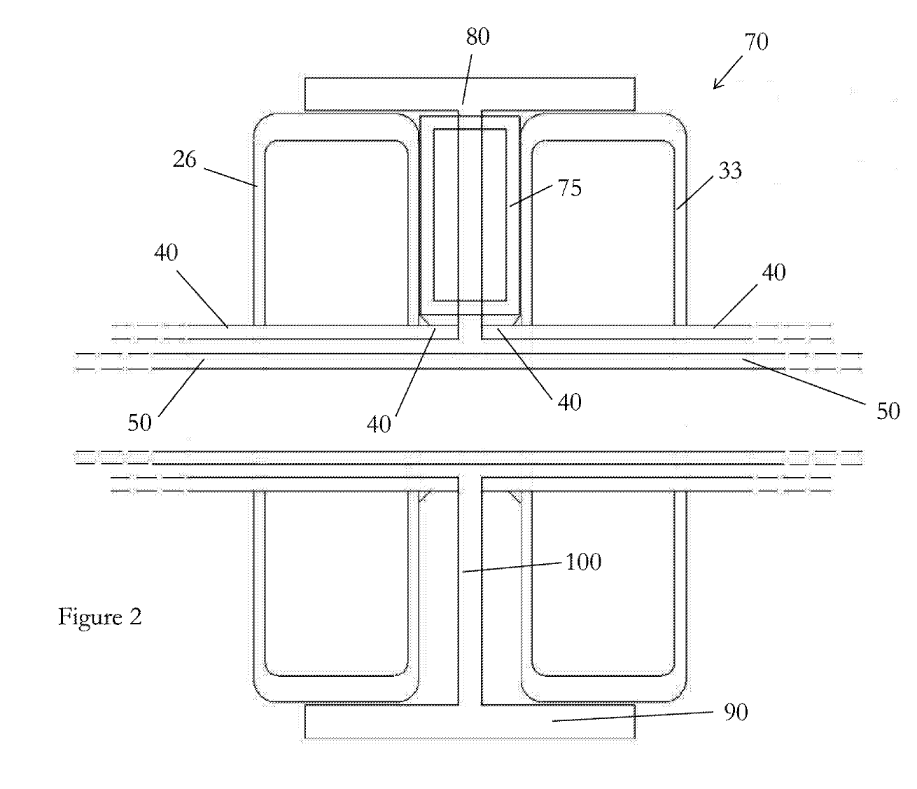

In FIG. 2, a close-up view of a stabilising member 70 is shown with its upper 80 and lower 90 surfaces, connecting web 100, and elongate member 50 passing therethrough.

Also shown is an infill member 75 which has a rectangular shape and which is arranged between the stiles such that its upper surface is flush with the upper surfaces of the stiles 26, 33. It rests on the projecting rungs 40. In this case, the infill member 75 is integral with the stabilising member 70, but it is contemplated that may be used separately from the stabilising member.

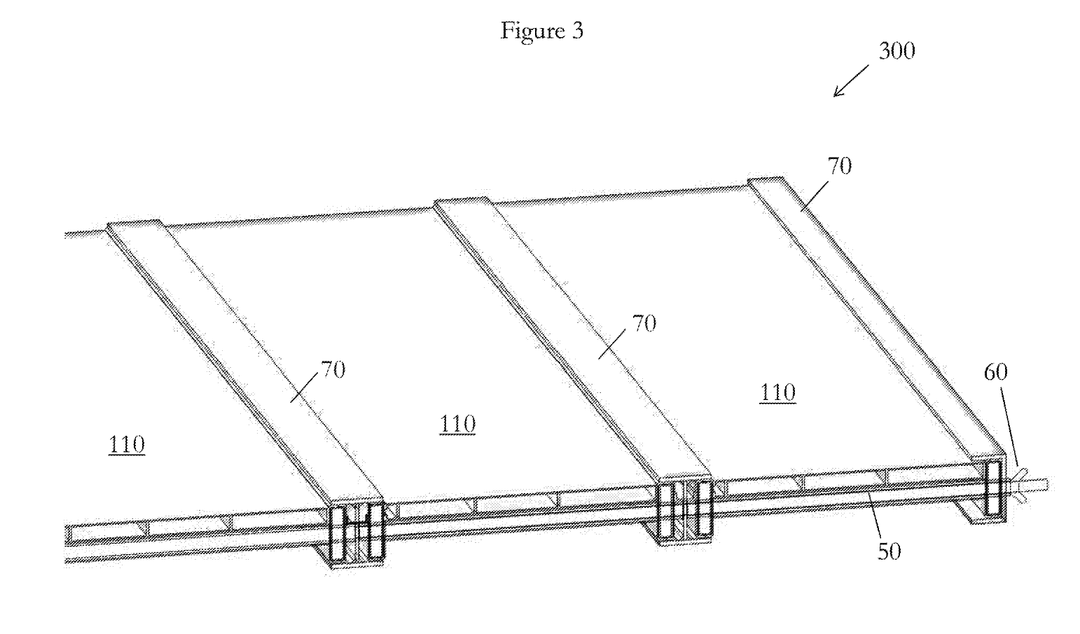

It is possible to connect more than two ladders side-by-side using the components described herein such that a larger platform 300 is created as shown in FIG. 3. In this case, the platform has stabilising members 70 which extend all along the lengths of the stiles.

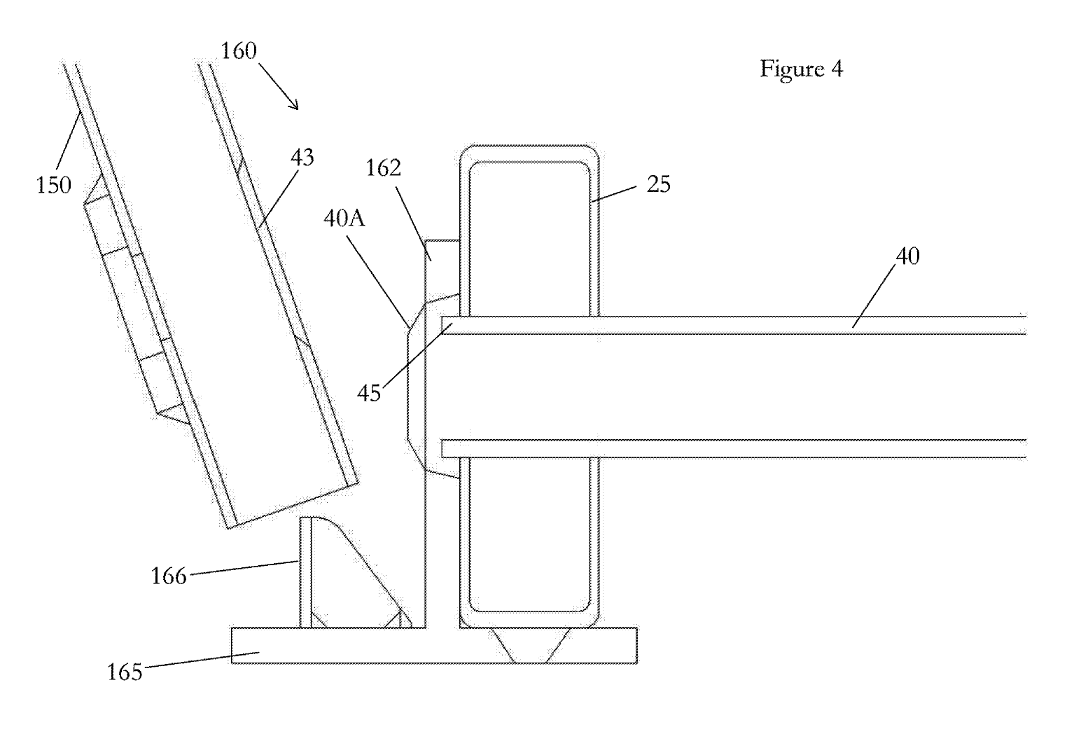

In FIG. 4, one end of a rung 40 and one stile 25 are shown. A side bracket 160 is shown having a vertical plate 162 and a horizontal plate 165 connected to the lower end of the vertical plate 162, together forming an inverted Roman letter “T”. The vertical plate 162 includes a hole such that the plate does not foul the end 45 of the rung which projects slightly through, as shown. This hole acts to locate the bracket 160. The plate 162 includes a tapered tube portion 40A projecting away from the side of the plate opposite to the side which contacts the side of the stile 25. The bracket 160 also includes a baluster receiver 166 in the form of a tubular portion attached, or integral, with the upper surface of the horizontal plate 165. This allows a baluster 150, with a hollow end portion, to be placed over the tubular portion and thus hold it in place. The tapered tube portion 40A fits into a recess 43 provided in the side of the baluster. Additional releasable fixers, such as grub screws, may be used to retain the baluster to the tubular portion 166. Alternatively, a nut could be screwed onto an elongate member 50, such as a threaded bar, placed through the hollow rungs to clamp the baluster 150 between the outer side surface of the stile and the nut.

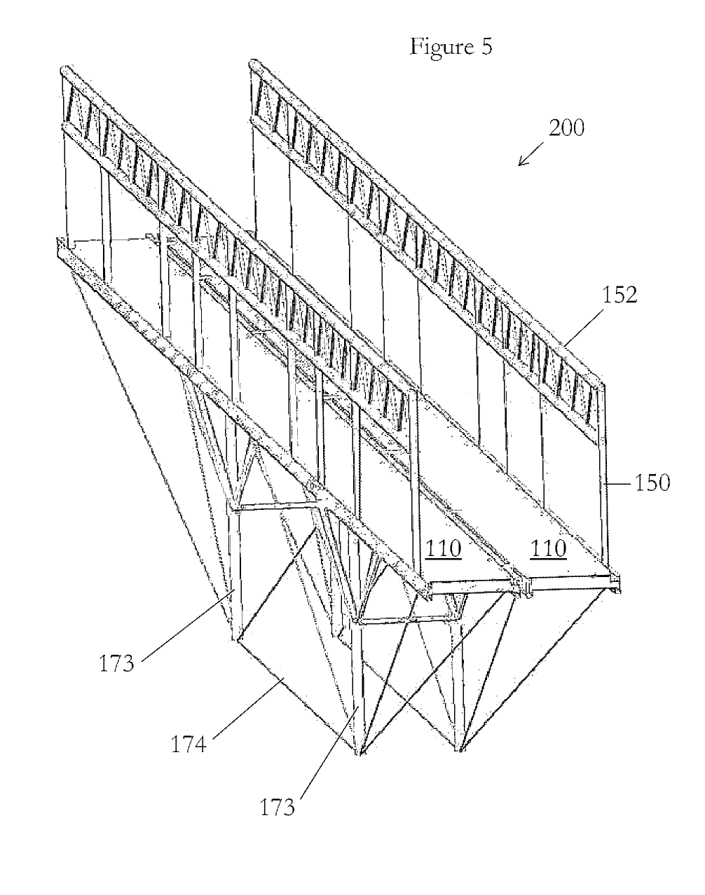

FIG. 5 shows a possible scenario whereby the platform is in the form of a bridge 200 including decks 110, balusters 150 and a hand rail 152.

Masts 173 are attached underneath the platform extending vertically away from its underside. Cables 174 are attached to the deck and pass over/attach to the masts 173 to provide stiffening to the bridge.

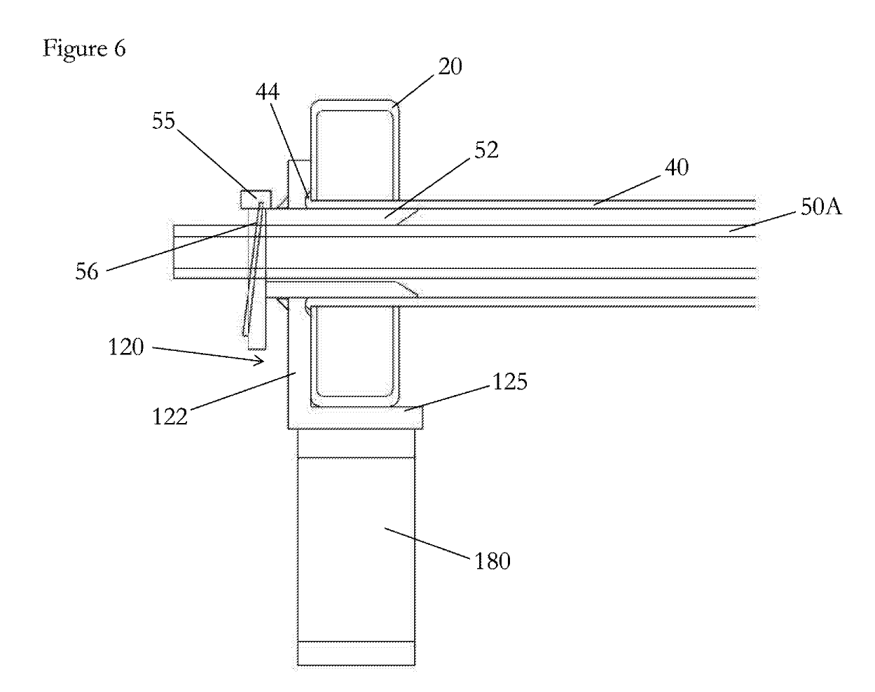

Another possible way of clamping two ladders together is shown in FIG. 6. In this example, the elongate member 50A comprises a hollow tube. It has a slightly smaller diameter than the bore of the rung 40 and as such a collar 52 is arranged at the end of the rung to fill the gap between the elongate member and the rung to retain it in place radially. A pin 55 passes through a hole 56 in the elongate member 50A adjacent the end of the rung 40 to retain the elongate member in place axially.

A side bracket 120 is shown attached to the platform. This side bracket 120 has a vertical plate 122 and a horizontal plate 125 connected to the lower end of the vertical plate 122, together forming a Roman letter “L” shape. The vertical plate 122 includes a hole such that it may accommodate the collar 52 which projects beyond the side of the stile so that it acts to locate and support the bracket 120. The bracket 120 also includes a short tubular portion 180 attached to, or integral, with the lower surface of the horizontal plate 125. This allows a stiffening member 140 to be attached to the underside of the platform as shown in FIG. 1.

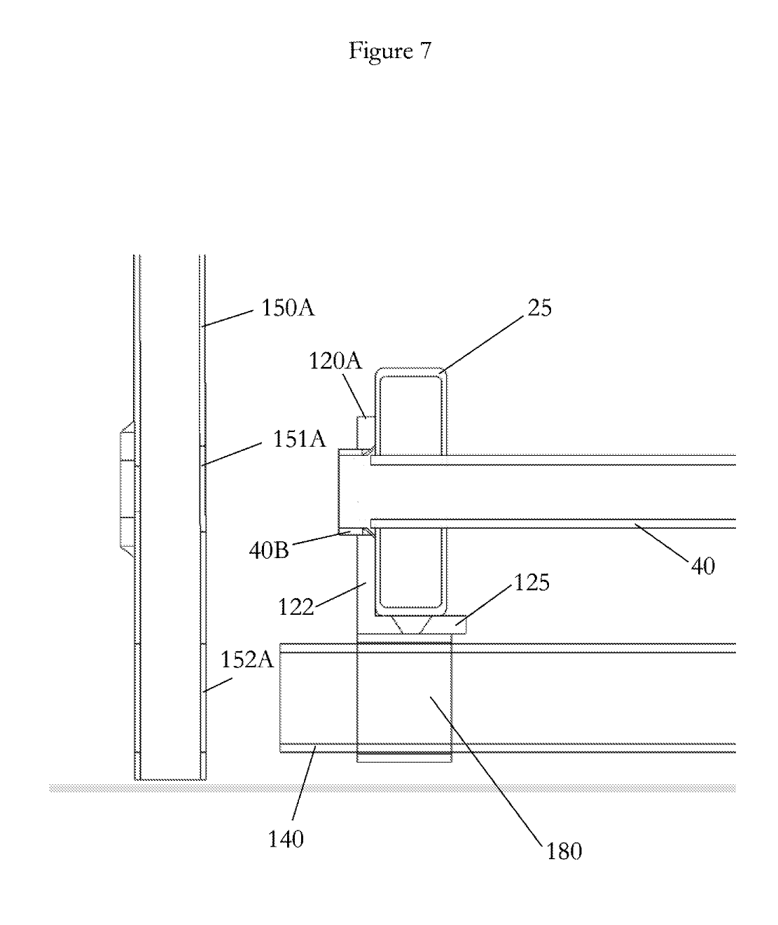

FIG. 7 shows an alternative way of securing an alternative baluster 150A to the platform using an alternative bracket 120A. This side bracket 120A has a vertical plate 122 and a horizontal plate 125 connected to the lower end of the vertical plate 122, together forming a Roman letter “L” shape in the same manner as the bracket 120 described in relation to FIG. 6. The vertical plate 122 includes a hole such that the plate does not foul the end of the rung which projects slightly through, as shown. This hole acts to locate the bracket 120A. The plate 122 includes a tapered tube portion 40B projecting away from the side of the plate opposite to the side which contacts the side of the stile 25. The tapered tube portion 40B fits into a recess 151A provided in the side of the baluster 150A. the baluster also includes a hole 152A arranged to fit over the stiffening member 140 arranged in the short tubular portion 180 attached to the bottom of the bracket 120A. The baluster 150A may be held in place by fixers attached over the end of an elongate member (not shown) which extends through the hollow rung and extends outwardly of the baluster on the side away from the stile 25. For instance, a butterfly nut may be used. The nut may be screwed onto the elongate member which may be a threaded tie rod.

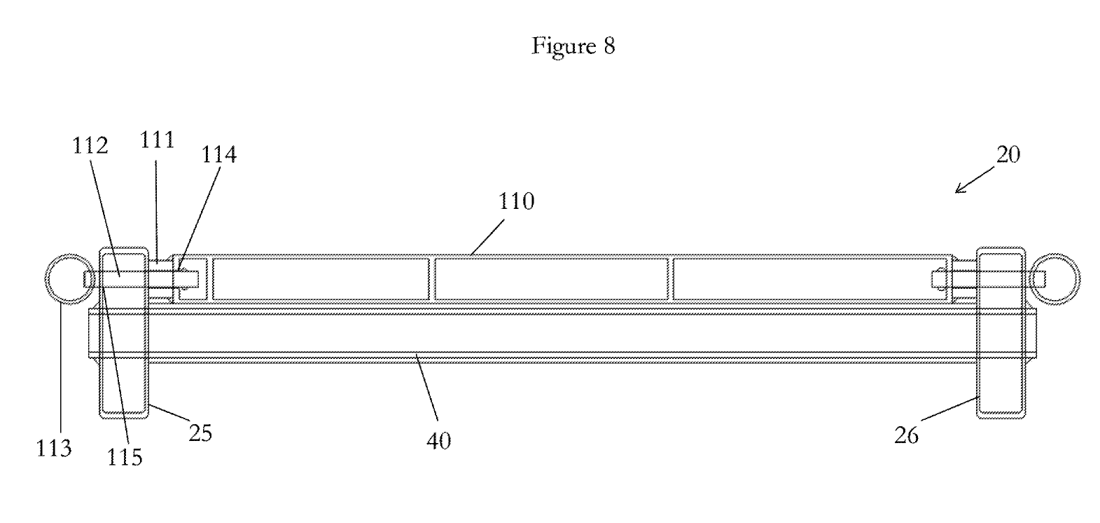

A deck plate 110 is depicted in FIG. 8 in place on top of the rungs 40. It has a box section and a planar upper and lower surface. The sides have holes 114 through which pins 112 may pass after having passed through co-axial holes 115 provided through the stile 25. A ring 113 provides easy grip of the pin 112.

The platform also includes spacing elements 111 arranged between the deck plate 110 and the inside surface of the stile 25. These act to maintain the sides of the deck plates away from the inside surfaces of the stiles. The pins 111 may pass through these spacing elements 111. Seal members (not shown) are also arranged between the deck plate 110 and the inside surface of the stile 25. These provide a degree of water-proofing to the platform such that it could be used in a vertical position as a barrier to fluids. The seal members may be arranged on the deck plates, on the ladders, or may be separate. The pins 112 may pass through the seal members, although it is preferable that the pins and seal members do not meet to ensure a water-tight connection.

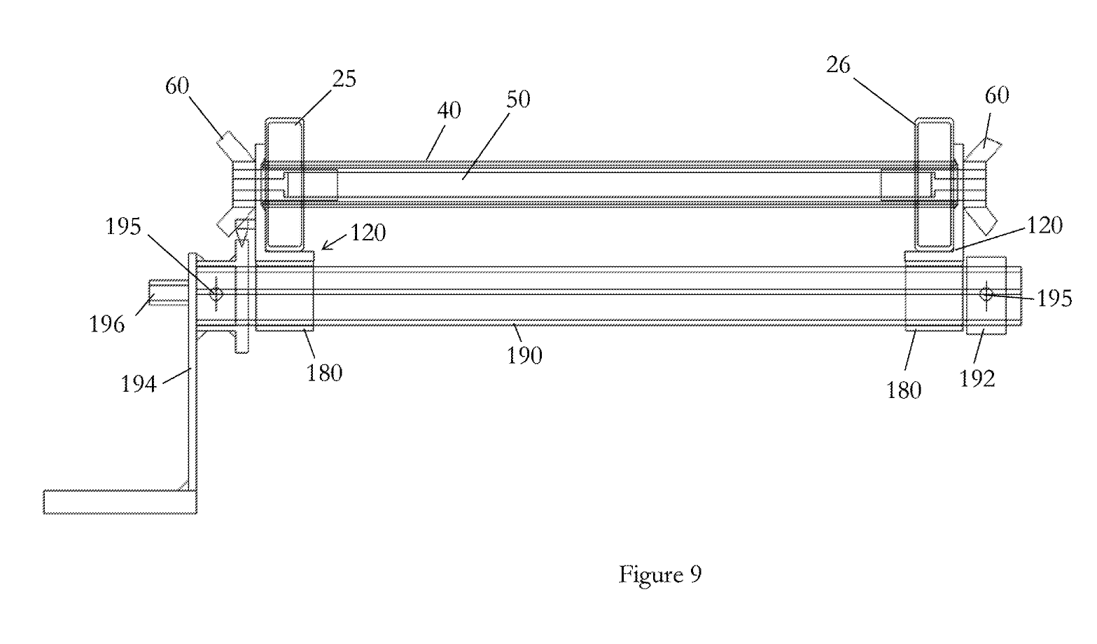

The side brackets 120 allow for other components to be attached to the platform. In FIG. 9 a winder is shown rotatably attached to the underside of one of the ladders forming the platform. This comprises of a tubular portion 190 which passes through the tubular portions 180 of the side brackets 120. A collar 192 is fixed to one end of the tubular portion 190 be use of a grub screw 195 or pin. A winding handle 194 is attached to the other end. The winder may be used to wind in a cable for movement of goods across the platform. A stub 196 is provided at the axial end of the tubular portion 190 such that an electric motor may be used to rotate the winder. The winder may extend across more than one ladder width.

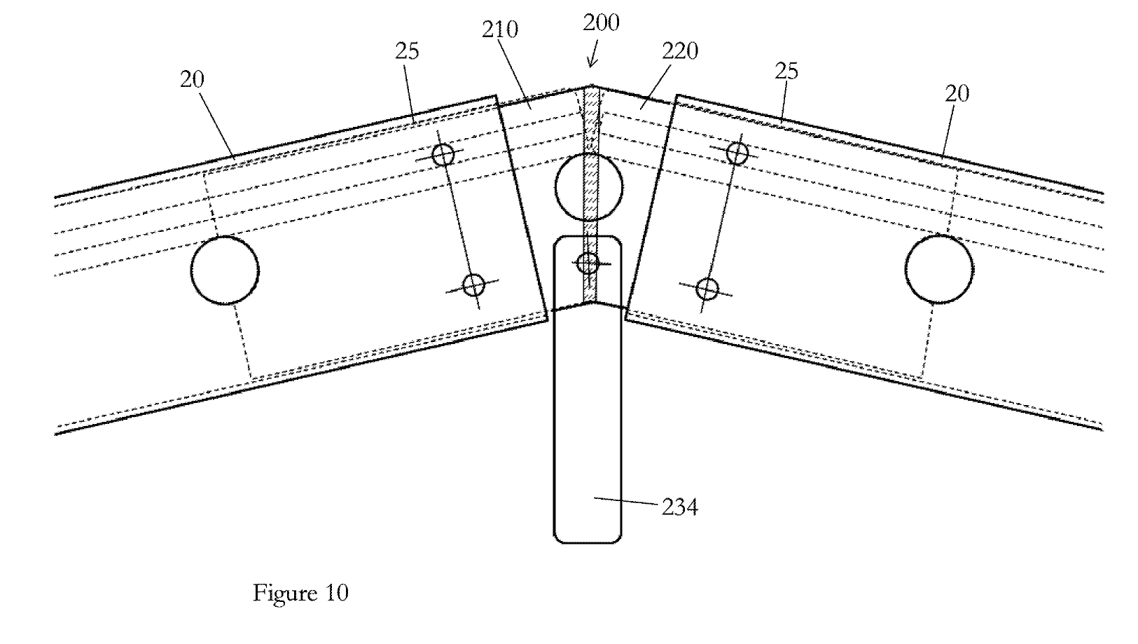

It is possible to connect two platforms together by use of a connection member. This connection member may fit into the hollow ends of co-axial stiles to maintain the stiles of both platforms in the same plane. Alternatively, the connection member 200 may include portions attachable to each platform such that the stiles of each platform are in different planes, such that they are at an angle to one another different from 180 degrees. An example is shown in FIG. 10. The connection member 200 includes a first portion 210 which fits snugly into the end of a stile 25 of one ladder 20 of one platform and a second portion 220 which fits snugly into the end of a stile 25 of one ladder 20 of the other platform. A member 234 depends downwardly, in use, from the connection member 200. This may be used to connect further connecting members to stiffen the roof. This member 234 may be omitted in one example.

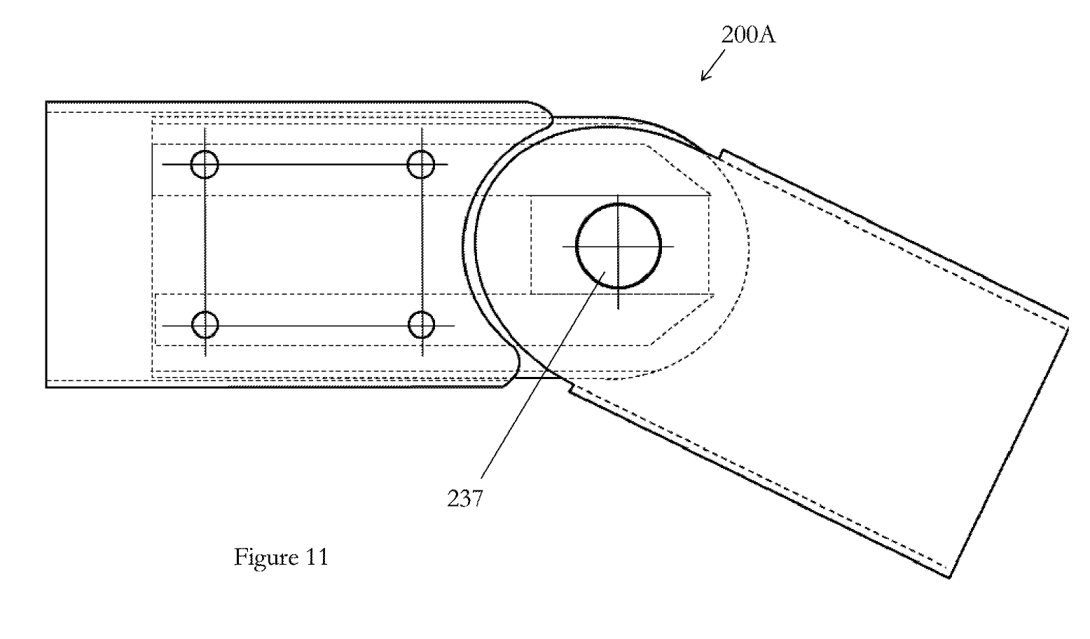

It is also possible to have a variable angle connection member 200A as shown in FIG. 11. This includes a pivoted joint 237.

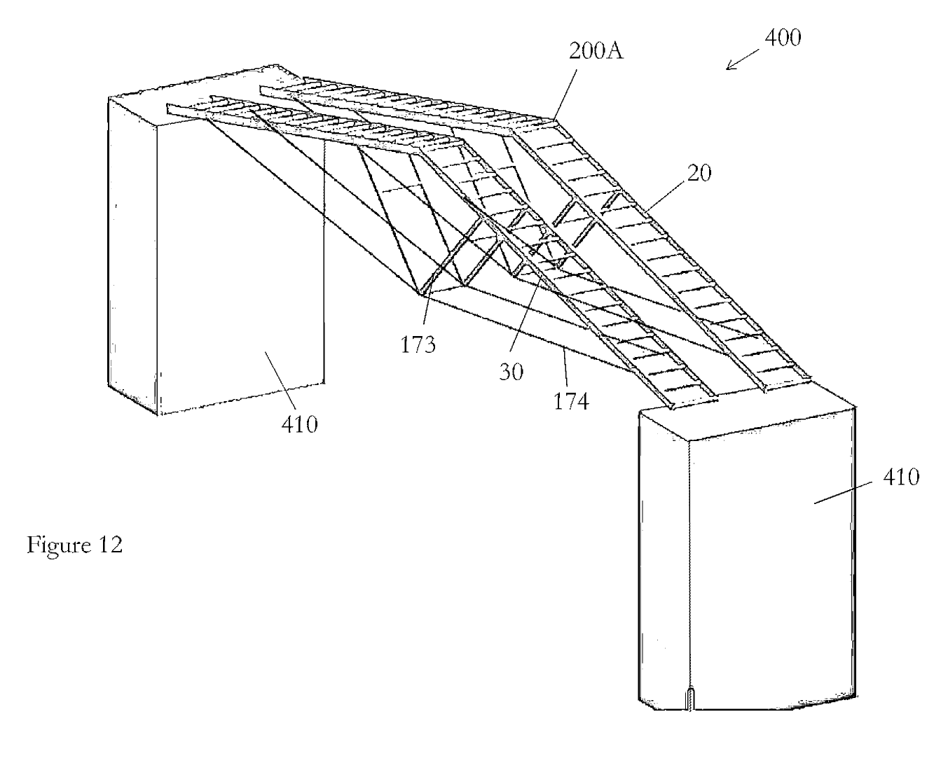

By using such platform connection members 200A, an apex roof structure 400 is constructible as shown in FIG. 12. The ladders 20, 30 shown in this figure are not shown connected adjacent one another to aid the drawings understanding. Masts 173 and cables 174 are provided underneath the platforms to provide stiffness therein. The roof is shown resting on walls 410. Once deck plates 110 are installed, together with the seals, the area underneath will be protected from the weather. It is possible that earth or other material may be placed on top of the roof to provide camouflage, further protection from the weather, or indeed protection from armaments.

1. A platform comprising:
two or more ladders, of the type having stiles and rungs, releasably attachable together in a side-by-side arrangement such that the rungs of each ladder are in the same plane, at least two of the rungs on each ladder being hollow;
a first elongate member arranged to pass through co-axially positioned hollow rungs of each ladder, the first elongate member comprising a widened portion at one end thereof, and a releasable locking member at the other end thereof, to releasably clamp the ladders together; and
at least one deck plate arrangeable on the rungs of one of the two or more ladders to form a deck.

2. The platform of claim 1, wherein the releasable locking member is a pin arranged to extend at least partially into a hole arranged in the first elongate member.

3. The platform of claim 1, wherein the widened portion is arranged to be reversibly transformable into a narrower portion to allow its passage through the hollow rung.

4. The platform of claim 1, further comprising:
a stabilising member arranged for placement between two adjacent ladders to maintain the rungs of both ladders in the same plane without the elongate member.

5. The platform of claim 4, wherein the stabilising member has a cross-sectional “I” shape in the form of two parallel flanges spaced apart from one another by an intermediate perpendicularly arranged web, the web arranged to be positioned parallel to, and between, the outer side surfaces of the adjacent stiles, one flange arranged to lie adjacent and parallel to the upper surfaces of the two adjacent stiles of the two adjacent ladders, and the other flange arranged to lie adjacent and parallel to the lower surfaces of the two adjacent stiles.

6. The platform of claim 4, wherein the stabilising member includes a hole to accommodate the first elongate member.

7. The platform of claim 4, wherein the stabilising member includes a bracket for attaching a stiffening member across the width of one or more of the two or more ladders.

8. The platform of claim 4, wherein at least some of the rungs project through an outer surface of the stile, the platform further comprising a removably attachable side bracket including a hole, the hole arranged to fit around a projecting rung, the side bracket attachable to the platform by use of the first elongate member and releasable locking member, the side bracket arranged to enable other members to be releasably attached to the platform.

9. The platform of claim 1, further comprising:
at least one baluster, the baluster attachable to the platform by use of the first elongate member and releasable locking member.

10. The platform of claim 9, further comprising:
a handrail releasably attachable to the at least one baluster.

11. The platform of claim 1, wherein the at least one deck plate includes projections for preventing it from them sliding across the rungs.

12. The platform of claim 1, wherein at least one stile includes a hole through its side arranged to receive a pin for releasably attaching the at least one deck plate to the platform.

13. The platform of claim 1, further comprising:
an infill member for filling a gap between outer side surfaces of the immediately adjacent stiles of the two adjacent ladders.

14. The platform of claim 13, wherein the infill member has a “T” shape.

15. The platform of claim 13, wherein the infill member has a square shape.

16. The platform of claim 1, further comprising:
a platform connector for connecting it to another platform.

17. The platform of claim 16, wherein the platform connector is arranged to connect the two platforms such that all the rungs lie in the same plane.

18. The platform of claim 16, wherein the platform connector is arranged to connect the two platforms such that all the rungs of one platform lie in one plane and all the rungs in the other platform lie in another plane.

19. The platform of claim 1, further comprising:
at least one releasably attachable mast and cord for stiffening the platform, the mast attachable such that its longitudinal axis lies non-parallel to the plane in which the rungs lie, the cord arranged to link the mast to the platform such that its longitudinal axis also lies non-parallel to the plane in which the rungs lie.

20. A method of assembling a platform according to claim 1, comprising:
providing at least two ladders, of the type having stiles and rungs, wherein at least two of the rungs on each ladder are hollow and placing these at least two hollow rungs co-axially and providing and inserting a first elongate member through them, the first elongate member comprising a widened portion at one end thereof;
providing a releasable locking member at the other end thereof and locking the locking member to the first elongate member to clamp the ladders together;
providing at least one deck plate and arranging it on the rungs of one of the two or more ladders to form a deck; and
providing at least one deck plate and arranging it on the rungs of one of the two or more ladders to form a deck.
